(19) United States
(12) Patent Application Publication
(10) Pub. No.: US 2010/0009194 A1
(43) Pub. Date: Jan. 14, 2010

(54) Method of making charge dissipative surfaces of polymeric materials with low temperature dependence of surface resistivity and low RF loss

(76) Inventors: Zelina Iskanderova, Toronto (CA); Jacob I. Kleiman, Thornhill (CA); Francois Bussières, Notre-Dame-De-L'Ile-Perrot (CA)

Correspondence Address: Franz BONSANG;c/o EQUINOX PROTECTION, 410 - 1500, Du College, St-Laurent, QC, H4L 5G6, CA

(21) Appl. No.: 12/458,486

(22) Filed: Jul. 14, 2009

Related U.S. Application Data
(60) Provisional application No. 61/129,709, filed on Jul. 14, 2008.

(51) Int. Cl. B32B 29/06; B29C 59/16

(52) U.S. Cl. 428/409; 264/446

(57) ABSTRACT

A method of making a charge dissipative surface of a polymeric material with low temperature dependence of the tunable surface resistivity, comprises the step of controllably carbonizing the surface of the polymeric material in a vacuum environment by bombarding the polymeric surface with an ion beam of rare gas ions, the energy level of the ion source being from low to moderate so as to reach a surface resistivity in the static dissipative range while having negligible impact on the RF transparency of the material and with tunable thermo-optical properties of the surface, including negligible impact on the thermo-optical properties.

### CROSS REFERENCE TO RELATED APPLICATIONS

Benefit of priority of U.S. Provisional Application for Patent Ser. No. 61/129,709, filed on Jul. 14, 2008, is hereby claimed.

### FIELD OF THE INVENTION

The present invention relates to the field of polymeric surface treatment, and more particularly to a method of making charge dissipative surfaces of polymeric materials with low temperature dependence of surface resistivity, over a wide temperature range, such as the one that can be seen for antennas in space, with high RF (Radio-frequency) transparency and/or with negligible impact on thermo-optical properties of the surface.

### BACKGROUND OF THE INVENTION

Ion implantation and/or ion bombardment is of growing interest in polymer science and engineering because of its demonstrated capability to modify the molecular structure, morphological structure, and the physical properties of polymers. During ion bombardment of polymers in vacuum at a wide range of conditions, the most common are the processes of polymer chain destruction due to energy transfer at atomic collisions and with following volatile final products release from the surface of the polymer, surface carbon content increase, called surface carbonization, and subsequent surface reconstruction. Changes in the index of refraction, optical transmission and reflection, and other optical properties of polymer films have been shown to follow ion implantation and ion bombardment of polymeric surface(s). Those are typically of significant impact, especially when used in space applications such as on spacecrafts, in order to control the mechanical and electrical performances of the material or the equipment on board. There may be a significant increase in density as a result of volume and density changes accompanying ion implantation of polymer materials. Few technical scientific papers deal with tribological, mechanical (optical)/electrical property changes (such as surface hardness, wear resistance, oxidation resistance, electrical conductivity), and these are generally limited mostly to the improvement of the adhesion of polymers to metals or metals to polymers, and this, with varying treatment conditions (such as ion energy level, ion beam current, ion beam total fluence, treatment duration, ion type, etc.). Some patents also discloses some work on ion implantation/bombardment on polymeric surfaces, such as U.S. Pat. No. 4,199,650 to Mirtich et al. granted on Apr. 22, 1980, U.S. Pat. No. 4,957,602 to Binder et al. granted on Sep. 18, 1990, U.S. Pat. No. 5,130,161 to Mansur et al. granted on Jul. 14, 1992, U.S. Pat. No. 6,248,409 to Kim granted on Jun. 19, 2001, U.S. Pat. No. 6,787,441 to Koh et al. granted on Sep. 7, 2004, and U.S. Pat. No. 7,309,405 to Cho et al. granted on Dec. 18, 2007.

However, none of the existing prior art discloses nor even suggests any studies/results of using ion beam treatments of thin polymer films for space antenna sunshields or any other relevant space applications.

When antenna applications in space are considered and that a dielectric is required in the RF field (for example sunshields in front of the radiating element and/or reflector of communication antennas), the material needs to be RF transparent (or permeable as much as possible to prevent signal losses), have good thermo-optical properties to control the temperature excursions of the antenna equipment, and have low, and not too low, electrical surface resistivity (SR) over the entire temperature range, and preferably remain stable thereover as much as possible (within about 10⁵ to 10¹⁰ ohms/square; SR to be above about 10⁵-10⁶ ohms/sq. for RF transparency and below 10⁹-10¹⁰ ohms/sq. to avoid ESD (electrostatic discharge) issues) to dissipate electrical charges without disturbing RF performance. It is also to ensure that these properties do not degrade too much over time when those materials to be exposed for years in a specified space environment, for instance, such as geosynchronous earth orbit (GEO) space environment, that might include UV (ultraviolet), ionizing radiations, and thermal cycling in vacuum.

There are different ways of providing ESD (electrostatic discharge) protection to surfaces of dielectric-type materials in order to prevent charge buildups followed by damaging discharges on electrically sensitive surfaces, especially when dealing with active components such as antennas, electronics and the like, in space applications.

One of the ways used is to apply semi-conductor based coatings, such as silicon (Si) or germanium (Ge) under vacuum deposition processes, on the required surfaces. Such coatings have a tendency to provide for a significantly varying surface resistivity over large temperature ranges, from about −200° C. to about +200° C., as can be frequently encountered in space applications, with a generally too high SR at low end temperatures to achieve proper ESD protection. Furthermore, such coatings are known to be fragile or brittle (not robust), thus requiring careful handling, and may be sensitive to humidity level (mostly germanium).

Another known way is the application of an electrically conductive coating, such as indium-tin oxide (ITO), as in U.S. Pat. No. 5,283,592 granted on Feb. 1, 1994 to Bogorad et al. for an “Antenna Sunshield Membrane”. Disadvantages of this ITO coating is that, beside that it is also fragile (susceptible to cracking), it is too electrically conductive to be considered when RF transparency (or semi-transparency) is needed (as for a space antenna sunshield application or the like), as it behaves as a barrier to RF signals.

Another way of decreasing the SR of dielectric materials is to load the material with electrically conductive particles such as carbon or the like, as in U.S. Pat. No. 6,139,943 granted on Oct. 31, 2001 to Long et al. for a “Black Thermal Control Film and Thermally Controlled Microwave Device Containing Porous Carbon Pigments”. This loading of particles into the material significantly affects its mechanical thermo-optical properties, as well as its RF transparency properties, which considerably limit and essentially hinder its use in most space antenna applications.

Early sunshield consisted of Kapton™ dielectric sheet painted white, but the properties degraded over time on-orbit, decreasing thermal protection, and increasing RF signal loss. For ITO-coated white paint on black Kapton™ film and ITO-coated clear Kapton™ film with white paint on the second surface, RF losses in the frequency range 2.5 to 15 GHz were known to be on the order of 0.2 dB (decibel), which was not acceptable for operation with signals at Ku-band frequencies and above.

U.S. Pat. No. 5,373,305 granted on Dec. 13, 1994 to Lepore, Jr. et al. offers as an improved sunshield a pigmented flexible film of 0.0005 to 0.003 in thick with germanium vacuum deposited on the space-facing side. Black-pigmented polyimide substrate (Kapton™ pigmented with carbon black) was preferred, as solar transmittance is virtually zero. The RF loss for uncoated polyimide or polyetherimide film is quoted as being less than 0.02 dB over the 2.5 to 15 GHz frequency range. The proposed black polyimide membrane sunshield construction adds another 0.03 dB for an RF loss of up to 0.05 dB at 15 GHz. Increased loss is expected when using carbon black for pigmentation. Moreover, the electrical conductivity of germanium (and the like semi-conductor coatings such as silicon) decreases at cold yielding to inadequate ESD protection at cold temperature and increases at hot temperatures yielding to higher RF losses and even possibly to a thermal runaway under high RF power signal densities travelling there through. This type of sunshield is therefore not promising for high-power and/or high-frequency operation, particularly in and above Ku-band and Ka-band frequencies.

Accordingly, there is a need for an improved charge dissipative surface of a polymeric material with low temperature dependence of surface resistivity while keeping RF performance thereof, and a method of making that surface.

### SUMMARY OF THE INVENTION

It is therefore a general object of the present invention to provide an improved charge dissipative surface of a polymeric material, preferably with low temperature dependence of the surface resistivity, without affecting RF performance, and with tunable thermal optical properties, including unchanged thermal optical properties thereof, and a method of making that surface.

An advantage of the present invention is that the method was established to make a charge dissipative surface of polymeric material (within a static-dissipative range being typically from 10⁵ to 10¹⁰ ohms/sq.) with comparatively low temperature dependence (SR typically remains within a 2-3 order of magnitude variation (100-1000 ratio factor) over a wide temperature range of up to at least 300° C. span, and up to very cold temperatures in the order of −150° C.) by controlling the carbonization of a thin external layer of the surface using preferably ion-beam surface treatment. The surface treatment preferably to be done by ion beams of rare gases, without affecting the mechanical and any other properties of the polymeric material underneath.

Another advantage of the present invention is that the method of making the charge dissipative RF transmitting polymeric surface can be performed to achieve tunable thermal optical properties in a way to decrease the solar transparency of the film, or to keep the thermo-optical properties of the untreated surface (changes almost undetectable when measured), depending on what is desired.

A further significant advantage of the present invention is that the method of making the charge dissipative RF transmitting polymeric surface allows providing a surface resistivity, that can be controlled in a wide range of a few orders of magnitude (typically anywhere between 10⁵ and 10¹⁰ ohms/square), and adjusted, or tuned to the desired level by the selection of treatment conditions. This is a very valuable advantage over the mentioned above thin semi-conductive coatings, that allow reaching just one particular surface resistivity (or a small range of SR) by the selection of the material itself.

Still another advantage of the present invention is that the method of making the charge dissipative polymeric surface allows the radio-frequency (RF) properties of the surface, and the material, to remain essentially unaffected (no measurable difference), even at high Ku- and Ka-band frequencies (and likely even higher frequencies).

Another advantage this invention is that, since surface resistivity is more stable over temperature than semi-conductor coatings, the RF power handling of the material will be significantly higher. Indeed, as the temperature goes up, the conductivity of the material (and thus ohmic losses) increases. At high RF power density, this can create a thermal runaway phenomenon leading to burning of the material (material heating due to RF losses and RF losses increasing with temperature). The RF power density at which the material will have a thermal runaway will be much higher for material treated as per this invention compared to semi-conductor coatings like germanium because the surface resistivity (or conductivity) is more stable over temperature.

Another advantage of the present invention is that the method of making the charge dissipative RF transmitting polymeric surface provides a surface that is very robust, i.e. not fragile, and stable over time.

A further advantage of the present invention is that the method of making the charge dissipative polymeric surface is based on a compositional change being “graded” into the material, as opposed to a coating, defining a sharp interface, which is often a weak point of the structure in regard of thermal cycling, thermal shock and adhesion.

Yet another advantage of the present invention is that the method of making the charge dissipative polymeric surface provides a surface that is resistant to the space radiation environment, such as multi-years exposure in the GEO space environment.

According to an aspect of the present invention there is provided a method of making a charge dissipative surface of a polymeric material with low temperature dependence of the surface resistivity, said method comprising the step of: controllably carbonizing the surface of the polymeric material.

Conveniently, the step includes controllably treating the polymeric surface with an ion beam, and preferably by impinging low and/or moderate energy rare gases ion beams at pre-selected treatment conditions (such as selected energy, flux, and fluence of the ion beam treatment, as well as the temperature of the polymeric surface), by carbonizing the surface of the polymeric material in a graded manner, forming an inorganic-organic, or carbonaceous-polymeric transition in the ion beam treated subsurface area, to form a charge dissipative surface with a required surface resistivity and low temperature dependence of the surface resistivity, without compromising the RF performance of the material and with tunable thermo-optical properties of the surface, if required according to applications.

According to an aspect of the present invention, there is provided a method of making a charge dissipative surface of a polymeric material with low temperature dependence of the surface resistivity, said method comprising the step of:
controllably carbonizing the surface of the polymeric material in a vacuum environment by bombarding the surface with rare gases ions from an ion beam source, said bombardment forming a thin carbonized top surface layer with a tunable surface resistivity in a static-dissipative surface resistivity range, with said low temperature dependence of the surface resistivity over a wide temperature range and with low RF losses.

Conveniently, the static dissipative range is between about 1×10⁵ and 1×10¹⁰ ohms/square at room temperature.

Conveniently, the wide temperature range spans over at least a 300° C. range, between about −150° C. to about +150° C.

Conveniently, the low temperature dependence of the surface resistivity over a wide temperature range is a variation of the surface resistivity within less than three orders of magnitude over 300° C.

Conveniently, controllably carbonizing the polymeric surface enables to achieve a static-dissipative material surface with low RF losses and high RF power handling.

Preferably, the RF losses are RF losses substantially unchanged relative to the RF losses of the untreated material when measured at room temperature at frequencies up to about 40 GHz.

Conveniently, controllably carbonizing the polymeric surface enables to achieve a static-dissipative material surface with tunable thermo-optical properties, including negligible changes in thermo-optical properties of the material.

Conveniently, the energy level of said ion beam source is from low to moderate.

Preferably, the energy level of said ion beam source is between about 2.5 keV and about 50 keV.

Typically, the depth of carbonization of said surface is between about 0.02 μm and about 0.2 μm.

Conveniently, the rare gas ions are sourced from Argon, Krypton or Xenon.

Conveniently, the method further includes heating the polymeric surface up to a temperature varying between about 65° C. and about 95° C. so as to reduce the treatment time.

Typically, the controllably carbonizing the polymeric surface enables to achieve a surface that is resistant to the space radiation environment over a pre-determined amount of time.

Preferably, the pre-determined amount of time is about 6 years in a geostationary earth orbit environment.

According to another aspect of the present invention, there is provided a charge dissipative surface of a polymeric material treated according to the above-mentioned method to get a low temperature dependence of the surface resistivity thereof over a wide temperature range, with said tunable thermal optical properties of the treated surface and said low RF losses in said treated surface.

According to a further aspect of the present invention, there is provided a method of making a charge dissipative surface of a polymeric material with low temperature dependence of the surface resistivity, said method comprising the step of:
controllably carbonizing the surface of the polymeric material in a vacuum environment by bombarding the polymeric surface with a source of rare gas ions, said bombardment forming the charge dissipative surface within a pre-determined static-dissipative surface resistivity range with said low temperature dependence of the surface resistivity over a wide temperature range, and preferably with low RF losses.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures in which similar references used in different Figures denote similar components, wherein:

FIG. 1 is a graphical presentation of test results of surface resistivity of charge dissipative polymeric surfaces with low temperature dependence of the surface resistivity in accordance with embodiments of the present invention, showing the measured surface resistivity over a wide temperature range;

FIG. 2 is a graphical test result of solar reflectance spectra of charge dissipative polymeric surfaces in accordance with embodiments of the present invention and of a pristine (non-treated) similar reference sample, when measured over a highly polished aluminum backing;

FIG. 3 is a graphical test result of solar reflectance spectra of charge dissipative polymeric surfaces in accordance with embodiments of the present invention, after testing in a GEO space environment simulator, that correspond to long-term, 5-6 years space flight at GEO equivalent irradiation for the surface of the material.

FIGS. 4(a) and 4(b) are graphical test results of XPS (X-ray photoelectron spectroscopy) surveys of ion beam treated charge dissipative polymeric surfaces of a thin film Kapton™ HN hydrocarbon polyimide, in accordance with embodiment of the present invention, and of a similar pristine (non-treated) reference polymeric surface, respectively;

FIGS. 5(a) and 5(b) are graphical test results of XPS surveys of a charge dissipative polymeric surface of a thin film of Clear Polyimide CP1 (partially fluorinated material), ion beam treated in accordance with an embodiment of the present invention, and of a similar pristine non-treated polymeric surface, respectively; and

FIGS. 6(a) and 6(b) are graphical presentations of results of the high resolution XPS spectra de-convolution of carbon C1s bonding state of a charge dissipative polymeric surface, ion beam treated in accordance with an embodiment of the present invention, and of a similar pristine non-treated polymeric surface, respectively.

### DETAILED DESCRIPTION OF THE PREFERRED EMBODIMENTS

With reference to the annexed drawings the preferred embodiment of the present invention will be herein described for indicative purpose and by no means as of limitation.

Surface carbonization by ion beam treatment of a surface of a polymeric material may be performed by a variety of ions, in a wide energy range, and includes a few main processes, such as energy transfer from the accelerated ions to the polymeric surface in atomic collisions, surface sputtering by ion bombardment, volatiles release, and the following surface composition and/or morphology changes, phase transformations, etc. The final results are very sensitive to the ion-material combination, ion beam energy, flux and to the ion beam fluence, i.e. total dose of ions interacting with the surface for the treatment duration. Temperature of the target may increase due to ion bombardment, if using the ion beams of high energy and/or fluxes, or by using an additional heater, and may also influence the final carbonization and properties after ion beam(s) treatment.

In the case of present invention, the selection of ions and energy range, from rare gases such as typically Ar, Ke or Xe of low (2.5-5 keV—kilo-electron Volt)—and preferably 2.5-3 keV, provided, for instance, by a powerful technological ion beam source, such as low energy linear, or racetrack-like ion beam source for production purposed, to moderate (5-50 keV and preferably 8-30 keV) energies was made, based on the inventors extensive knowledge and expertise, as well as the results of computer simulation and modeling, using the TRIM/SRIM (Transport/Stopping-and-Range of Ions in Matter) computer simulation software. These calculations are able to show the energy loss distribution in the bombarded subsurface layer, that allows estimating the thickness of the affected surface layer and the expected carbonized as a result of the proposed ion beam treatment. Successful results of the formation of a charge dissipative RF transparent carbonized surface layers on polymers, with the depth of about 200-2000 Å (angstroms, or 10⁻¹⁰ meter—about 0.02-0.2 μm), and more typically about 200-1000 μm (preferably about 0.1 μm), have been achieved with the ion beams of rare gases ions, such as Ar⁺, Kr⁺, and Xe⁺. In a vacuum environment (1×10⁻⁴ torr or less), those gases are easily out-gassed from the polymers during the ion beam treatment, when used at above-mentioned low or medium (moderate) energies and with some surface heating, and therefore do not introduce any doping elements (impurities). Ion beam currents/fluxes have been selected in the range from low, few μA (micro-Amp), i.e. from (3-5)6×10¹²/cm²/s up to high as parts of mA (milli-Amp), i.e. (0.2-0.3)6×10¹⁵/cm²/s (not to cause overheating of the thin polymer films), and total fluencies have been in the range from 1×10¹⁵/cm² up to (3-5)10¹⁷/cm². The surface resistivity decrease was more pronounced by the treatment with heavier ions and higher fluxes due to more extensive energy transfer, and achieved more easily on partially fluorinated polymers, that are more sensitive to ion bombardment. It has been found that going with significantly higher energy of the ions, i. e. acceleration voltage in the ion beam, or significantly higher ion beam currents, i. e. ion flux, raises significantly the power input in the polymer film, may most likely cause films destruction/burning or, at least, warping. Going with significantly higher energy would also carbonize a thicker portion of the film, which could result in higher RF losses. Using lower ion beam energies has been shown to limit strongly the ions penetration depth and to increase sputtering, instead of carbonization effect due to ion implantation. On the other hand, using lower ion beam currents, i.e. ion flux values immediately increases the treatment time. The treatment has shown to be successful with the polymer films in a wide temperature range, from room temperature (about 20° C.) up to about 65-95° C., during ion bombardment. The proposed temperature increase in this range allowed enhancing the thermally-activated processes, such as diffusion of gases in polymers and following volatiles de-sorption/release, and the polymers surface reconstruction to stable, robust, charge dissipative carbonized surface layers. One has to be careful not to increase too much the temperature, since it may cause, together with the heating due to the ion beam, an overheating, especially at the final stages of the treatment, therefore causing films destruction/burning or, at least, warping, but on the other hand, decreasing the films pre-treatment heating temperature would result in an increase of the treatment duration to achieve the same surface resistivity. This trend clearly indicated the way to increase the production rate, when performing the roll-to-roll or batch surface treatment of the required space polymer films, providing the charge dissipative surfaces with variable/tunable surface resistivity in a wide range of values, as illustrated in Table 1(a) and Table 1(b) herein below. However, when the minimum impact (almost negligible or undetectable) on the thermal-optical properties of the material surface is of concern, with all the other above-mentioned beneficial surface properties to be achieved, the use of medium mass ions, such as Ar⁺, at the lower energy, such as about 3 keV, and with the polymer films temperature kept around 60-65° C. has been found to be the most preferable.

The use of heavier ions (such as Kr and Xe) and the indicated temperature range during ion beam treatment allowed reducing the treatment time and extending the range of achievable SR values (lower SR in the order of 10⁵ ohms/sq. can be achieved with heavier ions due to increased energy transfer and reconstruction of the surface), that might be beneficial for other possible applications, that enhances the manufacturing feasibility of the proposed treatment technology.

In summary, the following ranges of parameters are found to be suitable for the method of the present invention of making a charge dissipative surface of a polymeric material by controlled carbonization thereof in a vacuum environment of 1×10⁻⁴ torr or less, the variation of these parameters providing for the control of the carbonization process:
ion energy level: from about 2.5 to 50 keV, and preferably from about 2.5 to 30 keV;
ion of various mass, preferably rare gas ions, such as Ar+, Kr+and Xe+
ion current level: from about 1 μA up to about 0.5 mA, and preferably from about 3-5 μA up to about 0.2-0.3 mA;
ion total fluence level: from about 10¹⁵/cm² up to (3-5)×10¹⁷/cm²;
treatment duration: from about 5 minutes to about 10 hours, and preferably from about 7 minutes to about 8 hours;
treatment temperature (including pre-heating in vacuum prior to carbonization): from about 15° C. to about 95° C., and preferably from about 20° C. to about 65° C.;

With the method of the present invention, of making a static-dissipative surface layer on a number of polymers by controlled carbonization, preferably via ion beam treatment of the surface of the polymer, the following characteristics are achievable, depending on the requirement(s):
a static dissipative surface that has a low temperature dependence (SR typically remains within a 2-3 order of magnitude variation (100-1000 ratio factor) over a wide temperature range of at least 300° C. span covering in particular the cold temperatures usually encountered in space applications (i.e. between about −150° C. to +150° C. and should keep low temperature dependence on a wider temperature range);
a static dissipative surface that is robust (not fragile) and typically stable under space radiation environment;
an optimized surface resistivity with negligible (not measurable) impact on RF properties of the polymer and the surface itself (RF transparent treatment) up to at least Ka-band frequencies;
a material with higher RF power handling capability (thermal runaway at high RF power density, such as up to about 500 W/cm² at Ku-band) compared to static-dissipative semi-conductor coatings like germanium (having a thermal runaway at about 50-150 W/cm² at Ku-band).
an optimized surface resistivity with little impact on thermo-optical properties (solar absorptance, solar reflectance (diffuse and directional), IR (infrared) emittance, etc.) of the surface, if required.

Typically, the adjustment of the SR to desired range (within about 10⁵ ohms/sq. up to about 10¹⁰ ohms/sq.) is achieved by controlling the ion-beam treatment parameters (flux and/or energy level of the ion beam, treatment duration, materials temperature, etc.), the stronger and/or longer the treatment is, the lower the obtained SR is, with some natural limitations, when the SR levels up, i.e. becomes independent of further treatment duration.

### EXAMPLES

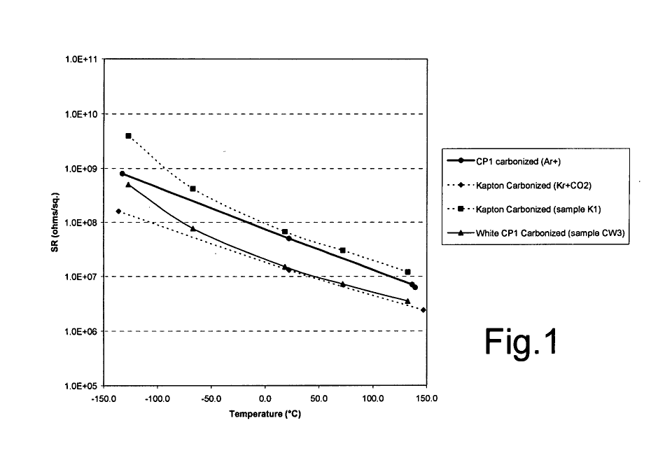

FIG. 1 illustrates the behavior of surface resistivity (SR) measurements with temperature in the range from −140° C. to +140° C. for two surface carbonized samples, namely, CP-1 (partially fluorinated Clear Polyimide manufactured by ManTech SRS Technologies, Inc. from Alabama, U.S.A.) treated by Ar⁺ ion-beam and Kapton™ HN exposed to Kr⁺ ion-beam bombardment. It is clear that the temperature dependence of SR is quite low compared to semi-conductor coatings like germanium and silicon (SR of surface carbonized samples varies by 2-3 orders of magnitude (100-1000 ratio factor) over the specified temperature range compared to typically 4-5 orders of magnitude (10,000-100,000 ratio factor) for silicon or germanium).

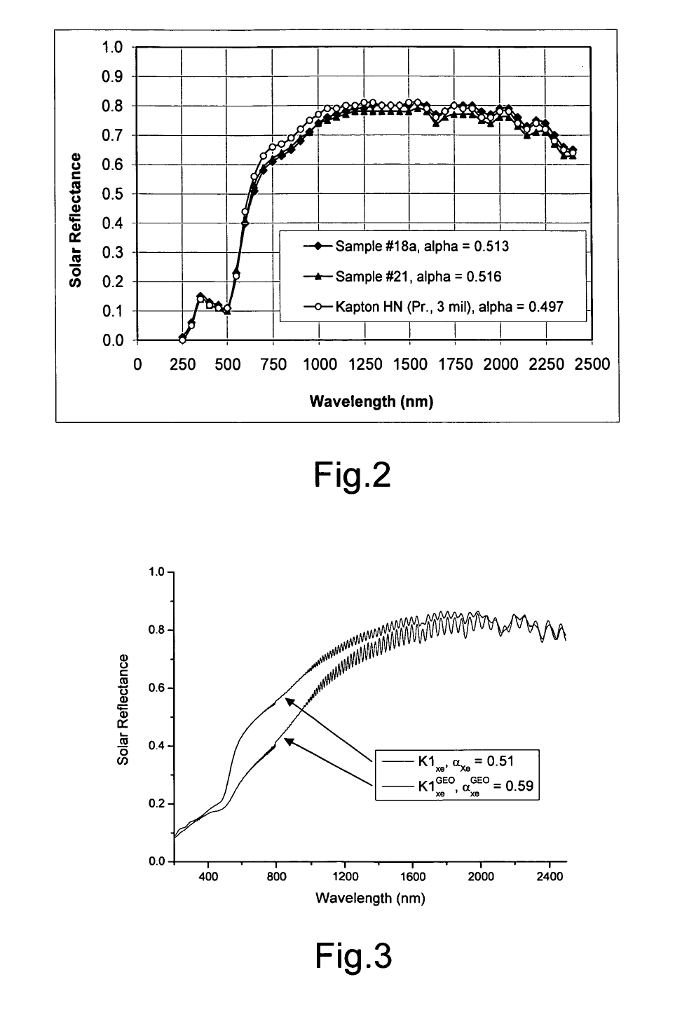

FIG. 2 illustrates the possibility to have a polymer surface with minimum influence of the proposed ion beam treatment on solar reflectance—the most sensitive thermal optical property of a variety of space polymer films. With the surface resistivity in the range 2-3 MΩ/sq. (sample No: 18a of Table 1b) or 10-20 MΩ/sq. (sample No: 21 of Table 1b), solar reflectance change (measured over an aluminum backing) does not exceed 0.02 from a similar pristine non-treated reference sample as can be seen from FIG. 2.

FIG. 3 illustrates the typical outstanding radiation resistance of the charge dissipative Kapton™ HN surface developed by the proposed ion beam treatment of the present invention. Testing was performed at about 20° C. using simultaneously applied three main space radiation factors, such as protons, electrons, and UV, using 20 keV protons with flux level of 10¹¹ p⁺/cm²/s and fluence level of 1.5-4.7·10¹⁵ p⁺/cm²; 10 keV electrons with flux level of 10¹² e⁻/cm²/s and fluence level of 4-7·10¹⁶ e⁻/cm², and UV exposure of one equivalent sun (1 eq.Sun). The conditions for charged particles irradiation have been selected using advanced GEO space environment models similar to NASA™ AP-8 and AE-8 with the goal to complete the imitation of long-term, ˜5-6 years in flight GEO exposure in a reasonable timeframe at the ground-based testing. The UV intensity equal to 1 equivalent sun (no accelerated testing) has been chosen not to disturb the chemical structure of the surface layer of thin polymer films by intensive UV radiation, for instance, such as cross-linking. Testing using separate and combined GEO space factors in this facility has convincingly proven that the main damaging factor for space-related thermal control polymer-based materials is proton irradiation.

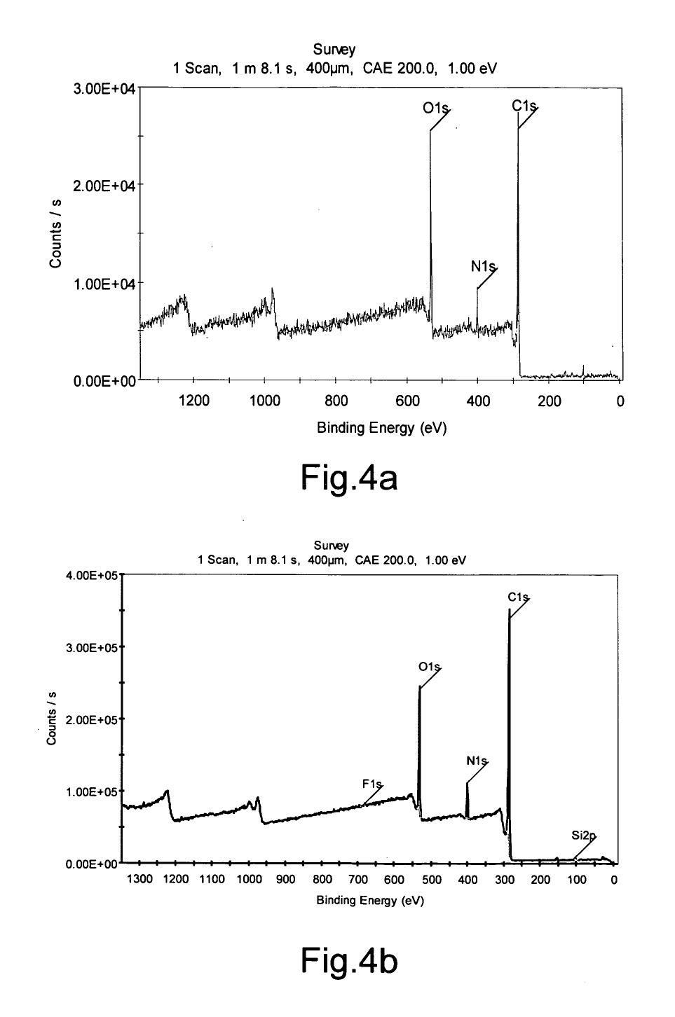

FIGS. 4a and 4b show XPS (X-ray photoelectron spectroscopy) survey scan results for ion beam treated Kapton™ HN and similar pristine (non-treated) reference sample, respectively. A comparison of those had clearly shown significant nitrogen depletion from Kapton™ hydrocarbon polyimide.

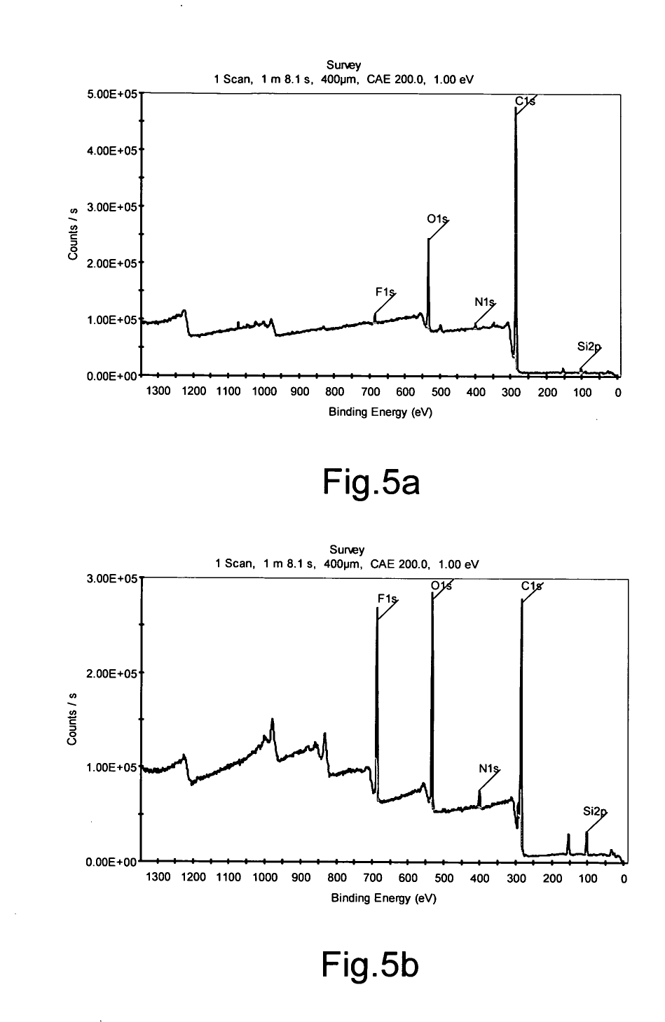

FIGS. 5a and 5b show XPS survey results and comparison of those for ion beam treated CP-1 sample and similar pristine non-treated reference sample, respectively, and have clearly shown significant nitrogen depletion and almost total depletion of fluorine from the partially fluorinated polyimide (CP-1).

To understand better the chemical processes and reconstruction of the surface of ion beam treated polymers, the high-resolution XPS was conducted.

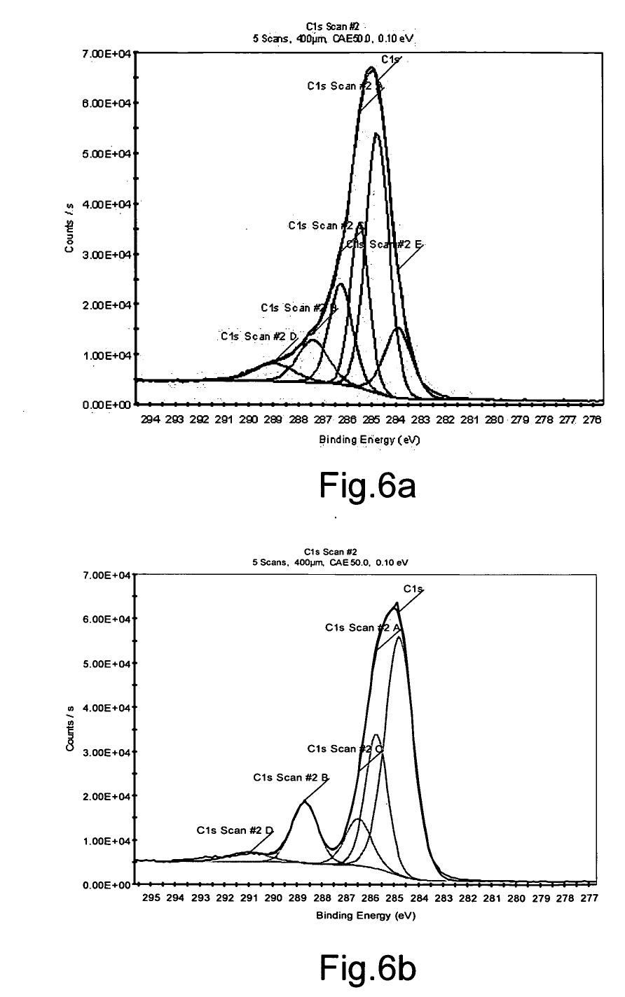

FIGS. 6a and 6b represent the spectral de-convolution of C1s bonding states for ion-bombarded Kapton™ HN and pristine non-treated reference sample, respectively. The comparison of FIGS. 6a and 6b indicate all types of chemical bonding reconstruction at the surface layer due to ion bombardment, from bonds destruction to bonding energy shifts and formation of new carbon-carbon bonding states, similar to those formed in vacuum deposited inorganic carbonaceous layers. Ion bombardment resulted in destruction and reconstruction of the polyimide main chemical groups on the surface. The high energy C1s peak at 285.7 eV that is present at FIG. 6b, disappeared at FIG. 6a, and three new peaks appeared. The high-resolution C1s spectra of all Kapton™ HN films after ion bombardment displayed similar changes for all investigated conditions. The main peaks at 284.3-284.7 eV at FIG. 6a is indicative of formation of a highly carbonized or graphitized surface, similar to the surface layers, developed on many high-performance aromatic polymers at ion implantation with higher energies and lower doses. So, XPS new peak at 284.3-284.7 eV at FIG. 6a in the present case can be assigned to graphitic-like, carbonaceous surface structures, containing so-called “adventitious C”.

Table 1a presents the results of surface resistivity (SR) measurements on 1 mil (25 μm) thick space polymer films, mentioned above, as well as CP-1 White, that clear CP-1 with added white pigments, after three different medium energy (8-30 keV in these cases) ion beam treatments at room temperature for surface modification/carbonization, two performed with Ar⁺, and one with Xe⁺. The Ar⁺-ion treatments have been performed at higher—Ar⁺(I)—and lower—Ar⁺(II)—energies, so, the results illustrate both ion mass and ion beams energy influence.

TABLE 1a
Surface resistivity of space polymer films treated for surface
carbonization at room temperature with moderate energy ion beams

| | Surface resistivity at room temperature, | | |
|---|---|---|---|
| Materials/Surface | ρ, Ω/sq | | |
| treatment | Xe⁺ | Ar⁺(I) | Ar⁺(II) |
| CP-1 White (sample 1) | 0.75 · 10⁷ | 2.5 · 10⁸ | 1.3 · 10⁷ |
| CP-1 White (sample 2) | 0.8 · 10⁷ | 3 · 10⁸ | 3 · 10⁷ |
| CP-1 (sample 1) | 0.6 · 10⁷ | 5 · 10⁸ | 1.3 · 10⁷ |
| CP-1 (sample 2) | 0.75 · 10⁷ | 5.2 · 10⁸ | 6 · 10⁷ |
| Kapton ™ HN (sample 1) | 1.5 · 10⁷ | 5 · 10¹⁰ | 3 · 10⁹ |
| Kapton ™ HN (sample 2) | 1.3 · 10⁷ | 3.5 · 10¹⁰ | 1.9 · 10⁹ |

Table 1b represents the functional thermal optical properties and surface resistivity of Kapton™ HN films, 1 mil and 3 mil thick, treated for surface carbonization by low-energy (3 keV) Ar⁺ high-flux technological ion beams at selected temperatures in the range of 20-85° C. In this manufacturing feasibility confirmation study, the sizes of the surface treated films, both width and length, have been significantly extended. The films temperature increase in the range from 20° C. to 85° C. due to heating by the intensive beam or additional heater drastically enhanced the surface treatment productivity and treatment quality. Both results may be associated with thermal enhanced diffusion and out-gassing of the volatiles from the ion bombarded surface layers and, subsequently, enhanced surface carbonization. For instance, higher temperatures allow performing the ion beam treatment of Kapton™ HN 1 mil film of 40 cm width and 180 cm length in only 6-7 minutes, to achieve the production of charge-dissipative Kapton™ HN in an economically feasible manner.

TABLE 1B
Functional properties of Kapton ™ HN films treated by low-
energy (3 keV) Ar⁺ ion beam at selected temperatures

| | | Apparent Solar | | Apparent Thermal | | |
|---|---|---|---|---|---|---|
| | | absorptance | | emittance ε (over | | Surface |
| | | α_{S} (with Al backing) | | gold standard) | | resistivity |
| Sample ID | | Pristine | Δα_{S} | Pristine | Δε | (MΩ/sq.) |
| #11, 1 | mil | 0.339 | 0.122 | 0.883 | 0.009 | 10-12 |
| #14, 3 | mil | 0.497 | 0.013 | 0.880 | 0.003 | 5-6 |
| #15, 3 | mil | 0.497 | −0.031 | 0.880 | 0.004 | 20-30 |
| #17, 1 | mil | 0.339 | 0.138 | 0.883 | −0.002 | 130-150 |
| #18a, 3 | mil | 0.497 | −0.003 | 0.880 | 0.004 | 2-3 |
| #18b, 3 | mil | 0.497 | 0.016 | 0.880 | 0.008 | 0.5-0.7 |
| #19, 3 | mil | 0.497 | −0.031 | 0.880 | 0.007 | 80-100 |
| #20, 1 | mil | 0.339 | 0.088 | 0.883 | 0.008 | 15-20 |
| #21, 3 | mil | 0.497 | 0.019 | 0.880 | 0.008 | 10-20 |

Table 2 represents the results of RF S-parameter measurements in waveguide at Ka-band of untreated and surface carbonized (medium energy ion beams treated) Kapton™ HN and CP-1 White. The differences between corresponding untreated and treated samples are within measurement uncertainty, so, the ion beam treatment has low or no impact (negligible impact) on RF properties of materials. Similar results have been achieved for all low energy ion beam treated films.

TABLE 2
RF performance of surface carbonized
and pristine (untreated) polymers

| | | Worst case meas. | |
|---|---|---|---|
| | | 26.5 to 41 GHz | |
| | | Insertion | Return |
| Sample | | Loss | Loss |
| ID | Description | dB | dB |
| Kap-HN | Kapton ™ HN (untreated) | 0.015 to 0.025 | 30 to 31 |
| K1 | Surface carbonized by ion-beam | 0.015 | 31 |
| | treatment Kapton ™ HN | | |
| Wht CP-1 | White CP-1 (untreated) | 0.031 | 25 to 26 |
| CW3 | Surface carbonized by ion-beam | 0.015/0.048 | 25 |
| | treatment | | |
| CW4 | white CP-1 | | |

Table 3 shows surface resistivity of thin (1 mil) Kapton™ films before and after 5 GEO-simulating radiation testing, using simultaneous p⁺+e⁻+UV exposure, with high acceleration factor, making the testing equivalent of about 5-6 years in GEO orbit for p⁺ and e⁻ on the surface (no acceleration for UV test, i.e. performed at 1 eq.Sun for UV) of a pristine (non-treated) reference sample and a surface carbonized sample. These results show that surface-carbonized Kapton™ HN has kept its surface resistivity almost unchanged (around 10⁷ Ω/sq.) after this GEO simulated irradiation, that is equivalent to long-term, about 5-6 years of GEO space flight radiation exposure.

TABLE 3
Surface resistivity of Kapton ™ films before
and after radiation testing

| | | | SR (Ω/sq.), |
|---|---|---|---|
| Material | Treatment | SR (Ω/sq.) | Rad. Tested |
| Kapton ™ HN, 1 mil | Pristine | >10¹² | 10⁹ |
| Kapton ™ HN, 1 mil | Ion beam treated | (13-25) · 10⁶ | 18 · 10⁶ |

Table 4 shows the power handling capability (local RF power density at which thermal runaway occurs) of surface carbonized material compared with typical germanium coated material, when tested in waveguide in vacuum at Ku-band.

TABLE 4
Power handling capability of surface carbonized and
germanium-based materials at Ku-band

| | Local RF power density to initiate |
|---|---|
| Material | thermal runaway (MegaWatts/m\hat{ }2) |
| Germanium coated Kapton ™ | 0.5 to 1.5 |
| Surface Carbonized Kapton ™ | ~5 |

The surface carbonization method of the present invention to achieve stable charge-dissipative surface could be useful for, but not limited to, the following space-related areas:
Antenna sunshields (over radiating elements and/or reflectors)
   To alleviate the known ESD concerns with semi-conductors coatings at cold temperatures (whenever colder than about −50° C./−100° C.).
   The other alternatives adequate for ESD over the entire temperature range all have higher RF impact.
Solar cells
   as a replacement to optically clear ESD coatings.
MLI (multi-layer insulation) materials
   uncoated polyimide is a ESD threat.
   other ESD coatings like ITO are fragile.
Second Surface Mirrors (SSMs)
   treatment of polymer instead of application of an optically clear ESD coating like ITO which is fragile.
Membrane antennas
   Many antenna constructions involve the usage of a polyimide film with a printed circuit. A ESD coating can be required on these antennas, which can be unpractical to apply and/or ineffective at cold temperatures (too high surface resistivity) and/or have too big RF impact.
Antenna radiating element supports
   A RF-transparent support is often required in radiating elements. To be RF transparent, these supports must be non-conductive, which poses an ESD threat. Surface carbonized polymers are a solution to this.
High power horn covers
   No material meeting the ESD requirements is currently available to use as a horn protective cover (sunshield and/or cover for contamination) for high frequency high power feeds (Ku-band at RF power above 1 kW and/or higher frequencies with high power densities). Indeed, a thermal runaway can occur with semi-conductors coatings like germanium since the conductivity of semi-conductors (and thus RF losses) increases significantly with temperature. The surface carbonized polymers are a possible solution to this since the conductivity is much more stable over temperature and can be tailored to the desired range.

The surface carbonization to achieve charge-dissipative surface could also be useful for non-space related applications. Indeed, untreated polymers will build-up static electricity charges, which is often a concern for handling or for performance of various electronic devices for which the polymer film is used as a substrate. Handling thin films of Kapton™ (or other polymers) for example can be difficult because the material will stick to itself or nearby surfaces due to static electricity. Having a charge-dissipative polymer would help resolve this and make the material easier to handle.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

We claim:

1. A method of making a charge dissipative surface of a polymeric material with low temperature dependence of the surface resistivity, said method comprising the step of:
controllably carbonizing the surface of the polymeric material in a vacuum environment by bombarding the surface with rare gases ions from an ion beam source, said bombardment forming a thin carbonized top surface layer with a tunable surface resistivity in a static-dissipative surface resistivity range, with said low temperature dependence of the surface resistivity over a wide temperature range and with low RF losses.

2. The method of claim 1, wherein said static dissipative range is between about 1×10⁵ and 1×10¹⁰ ohms/square at room temperature.

3. The method of claim 1, wherein said wide temperature range spans over at least a 300° C. range, between about −150° C. to about +150° C.

4. The method of claim 1, wherein said low temperature dependence of the surface resistivity over a wide temperature range is a variation of the surface resistivity within less than three orders of magnitude over 300° C.

5. The method of claim 1, wherein controllably carbonizing the polymeric surface enables to achieve a static-dissipative material surface with low RF losses and high RF power handling.

6. The method of claim 5, wherein said RF losses are RF losses substantially unchanged relative to the RF losses of the untreated material when measured at room temperature at frequencies up to about 40 GHz.

7. The method of claim 1, wherein controllably carbonizing the polymeric surface enables to achieve a static-dissipative material surface with tunable thermo-optical properties, including negligible changes in thermo-optical properties of the material.

8. The method of claim 1, wherein the energy level of said ion beam source is from low to moderate.

9. The method of claim 8, wherein the energy level of said ion beam source is between about 2.5 keV and about 50 keV.

10. The method of claim 1, wherein the depth of carbonization of said surface is between about 0.02 μm and about 0.2 μm.

11. The method of claim 1, wherein the rare gas ions are sourced from Argon, Krypton or Xenon.

12. The method of claim 1, further including heating the polymeric surface up to a temperature varying between about 65° C. and about 95° C. so as to reduce the treatment time.

13. The method of claim 1, wherein controllably carbonizing the polymeric surface enables to achieve a surface that is resistant to the space radiation environment over a pre-determined amount of time.

14. The method of claim 13, wherein said pre-determined amount of time is about 6 years in a geostationary earth orbit environment.

15. A charge dissipative surface of a polymeric material treated according to the method of claim 1 to get a low temperature dependence of the surface resistivity thereof over a wide temperature range, with said tunable thermal optical properties of the treated surface and said low RF losses in said treated surface.
